(19) United States
(12) Patent Application Publication
(10) Pub. No.: US 2004/0056872 A1
(43) Pub. Date: Mar. 25, 2004

(54) Apparatus and method for image rotation

(76) Inventors: Iming Pai, San Jose, CA (US); Huei-Mei Su, Cupertino, CA (US); Yun Lin, San Jose, CA (US); Liang Tang, Shanghai (CN)

Correspondence Address: RABIN & Berdo, PC, 1101 14TH STREET, NW, SUITE 500, WASHINGTON, DC, 20005, US

(21) Appl. No.: 10/654,905

(22) Filed: Sep. 5, 2003

(30) Foreign Application Priority Data
Sep. 19, 2002 (TW) 91121428

(51) Int. Cl. G09G 5/00

(52) U.S. Cl. 345/649

(57) ABSTRACT

An apparatus for image rotation. The apparatus includes a first memory, a frame buffer, a rendering module, and a rotation module. The rendering module renders a second image according to second image data, and stores the second image in the first memory. The rotation module detects a variation object changed between the first image and the second image, rotates the variation object as a rotation object, and replaces a partial image of the first rotation image in the frame buffer corresponding to the position of the variation object in the second image with the rotation object.

### BACKGROUND OF THE INVENTION

1. Field of the Invention

The present invention relates to an apparatus and method for image rotation, and particularly to an apparatus and method that rotates only desired elements of the image without rendering the entire image.

2. Description of the Related Art

In computer graphics, various applications corresponding to display appliances are developed. For example, a system and function for image rotation has been developed to display data at different positions and angles, specifically for notebook users.

FIGS. 1a and 1b show schematic diagrams of image rotation corresponding to monitor and frame buffer respectively. In FIG. 1a, the image 100 in the monitor is rotated −90° as the image 101. The image data corresponding to the image in the monitor stored in the frame buffer of computer system is shown in FIG. 1b. The image data 111 stored in the frame buffer 110 corresponds to the image 100 in the monitor, and the image data 112 stored in the frame buffer 110 corresponds to the image 101 in the monitor.

In the conventional image rotation method, after new image data is received, both hardware rendering and software rendering methods first render a new image according to the new image data, and render a rotated image based on the entire image. Since the entire image contains a large amount of data, the rotation process takes up system resources and is time-consuming if the entire image is rendered to rotate. However, the difference between each image rendered by the system is minor in practice, when, for example, only one object is moved or a new object appears. Therefore, the conventional image rotation method is inefficient.

### SUMMARY OF THE INVENTION

It is therefore an object of the present invention to provide an apparatus and method that rotates only desired elements of the image without rendering the entire image.

To achieve the above object, the present invention provides an apparatus and method for image rotation. According to an embodiment of the invention, the apparatus includes a first memory, a frame buffer, a rendering module, and a rotation module. The frame buffer stores a first rotation image corresponding to a first image. The rendering module renders a second image according to received second image data, and stores the second image in the first memory. The rotation module detects a variation object changed between the first image and the second image according to the first image and the second image, rotates the variation object as a rotation object, and replaces a partial image of the first rotation image in the frame buffer corresponding to the position of the variation object in the second image with the rotation object.

The apparatus further includes a display device to refresh and display the first rotation image in the frame buffer.

The first memory can be the system memory, and the rendering module and the rotation module can be implemented by software, and performed by CPU. Further, the first memory can be contained in the frame buffer, and the rendering module and the rotation module can be implemented by hardware, and performed by a graphics accelerator.

According to another embodiment of the invention, a method for image rotation is provided. First, second image data is received, and a second image is then rendered according to the second image data. Then, a variation object changed between a first image and a second image is detected according to the first image and the second image, and the variation object is rotated as a rotation object. Thereafter, a partial image of the first rotation image in the frame buffer corresponding to the position of the variation object in the second image is replaced with the rotation object.

The first rotation image is further, stored in a frame buffer, and the first rotation image in the frame buffer is displayed.

The second image is further stored in the system memory, and the rendering and rotation processes can be performed by CPU. Further, the second image is further stored in the frame buffer, and the rendering and rotation processes can be performed by a graphics accelerator.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIGS. 1a and 1b show the schematic diagrams of image rotation corresponding to monitor and frame buffer respectively;

FIG. 2 is a schematic diagram illustrating the system architecture of the apparatus for image rotation according to a first embodiment of the present invention;

FIG. 3 is a schematic diagram illustrating the system architecture of the apparatus for image rotation according to a second embodiment of the present invention;

FIG. 4a is a schematic diagram illustrating a 2D texture by 180° rotated into 3D texture;

FIG. 4b is a schematic diagram illustrating a 2D texture with 90° rotated into 3D texture;

FIG. 5 is a flowchart illustrating the operation of the method for image rotation according to the embodiment of the present invention;

FIG. 6 is a schematic diagram illustrating an example of image rotation according to the embodiment of the present invention;

FIG. 7 is a schematic diagram illustrating an example of texture mapping;

FIG. 8 is a schematic diagram illustrating another example of image rotation according to the embodiment of the present invention; and

FIG. 9 is a schematic diagram illustrating the process of image rotation and image refreshing.

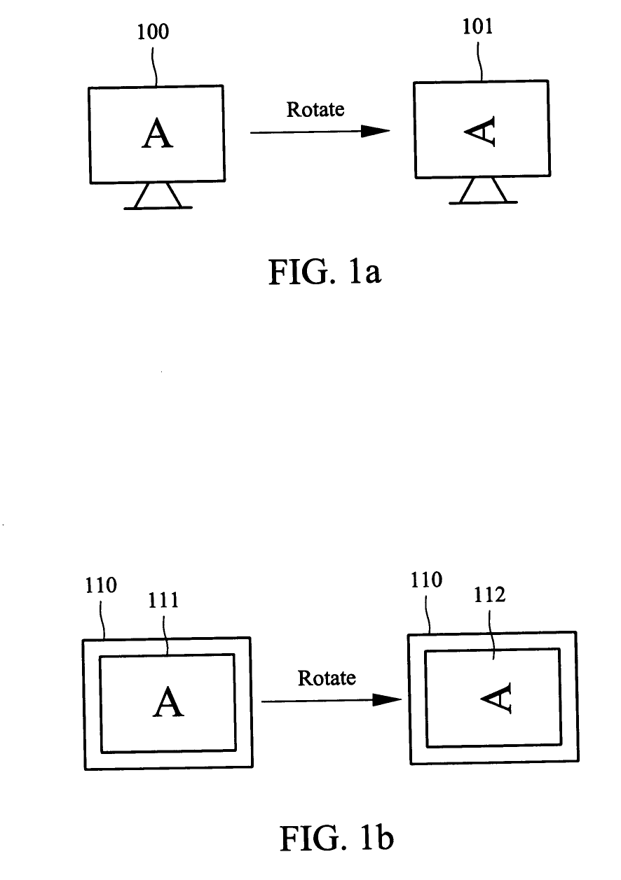

### DETAILED DESCRIPTION OF THE INVENTION

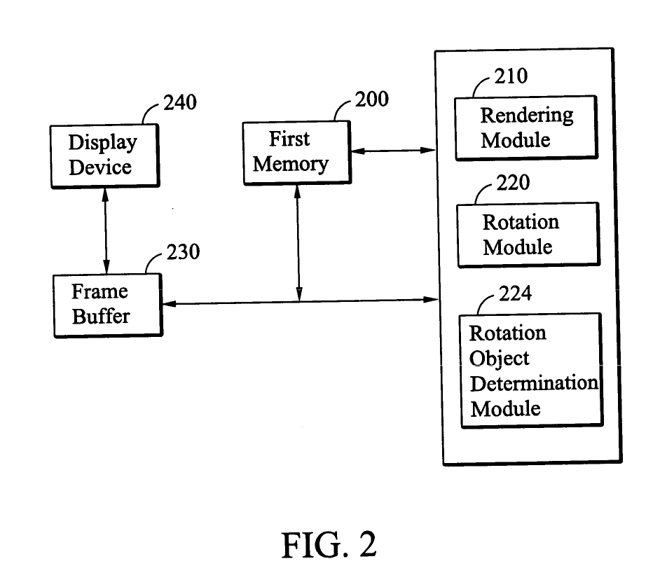

FIG. 2 illustrates the system architecture of the apparatus for image rotation according to the first embodiment of the present invention. The apparatus includes a first memory 200, a frame buffer 230, a rendering module 210, a rotation module 220, a rotation object determination module 224, and a display device 240. The rendering module 210, the rotation module 220, and the rotation object determination module 224 can be the components of a GPU (graphics processor unit).

The frame buffer 230 can be the memory on the DIMM (dual in-line memory module) or graphics adapter. The display device 240 refreshes and displays the image stored in the frame buffer 230.

The rendering module 210 receives image data from an application, and renders an image according to the image data. After rendering the image, the rendering module 210 stores the image in the first memory 200. The rotation module 220 uses the rotation object determination module 224 to detect at least one variation object changed between a prior image and the image, and acquires the variation object from the first memory 200. It should be noted that the prior image can be stored in the rotation module 220, and the rotated prior image is the image in the frame buffer 230.

The rotation module 220 then rotates the variation object as a rotation object according to a rotation requirement, and replaces a partial image of the image in the frame buffer 230 located at a position corresponding to that of the variation object in the image rendered by the rendering module 210. Afterward, the display device 240 can refresh and display the updated image in the frame buffer 230. It should be noted that the rotation requirement can be preset by system or users.

In the first embodiment, the rendering module 210 and the rotation module 220 can be implemented by software (software rendering) and performed by the CPU (central processing unit). Further, the first memory 200 can be the system memory of computer system when software rendering.

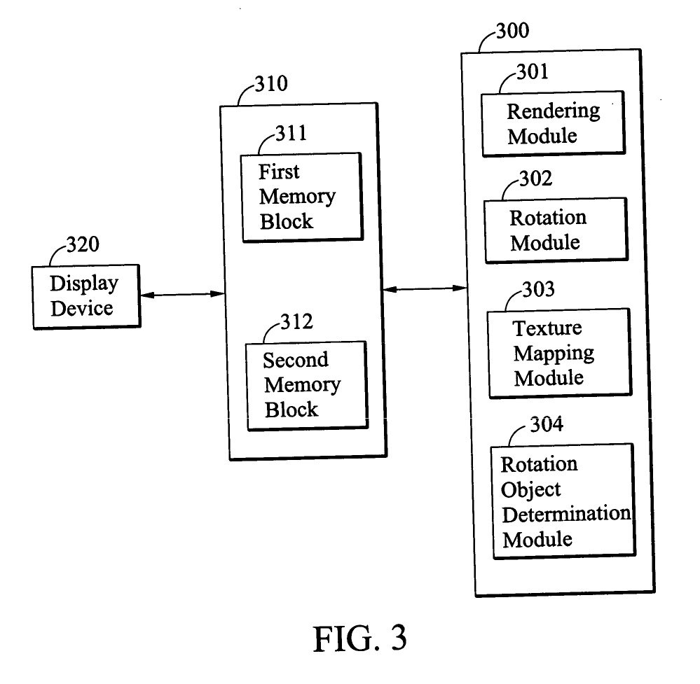

FIG. 3 illustrates the system architecture of the apparatus for image rotation according to a second embodiment of the present invention. The apparatus includes a 3D engine 300, a frame buffer 310, and a display device 320.

The frame buffer 310 includes a first memory block 311 and a second memory block 312. The display device 320 refreshes and displays the image stored in the second memory block 312.

The 3D engine 300 includes a rendering module 301, a rotation module 302, a texture mapping module 303, and a rotation object determination module 304. The rendering module 301 receives image data from an application, and renders an image according to the image data. For example, the rendering module 301 receives vertex data from the application and renders triangles of the image according thereto. After rendering the image, the rendering module 301 stores the image in the first memory block 311. The rotation module 302 uses the rotation object determination module 304 to detect at least one variation object between a prior image and the image, and acquires the variation object from the first memory block 311. It should be noted that the prior image can be stored in the rotation module 302, and the rotated prior image is the image in the second memory block 312.

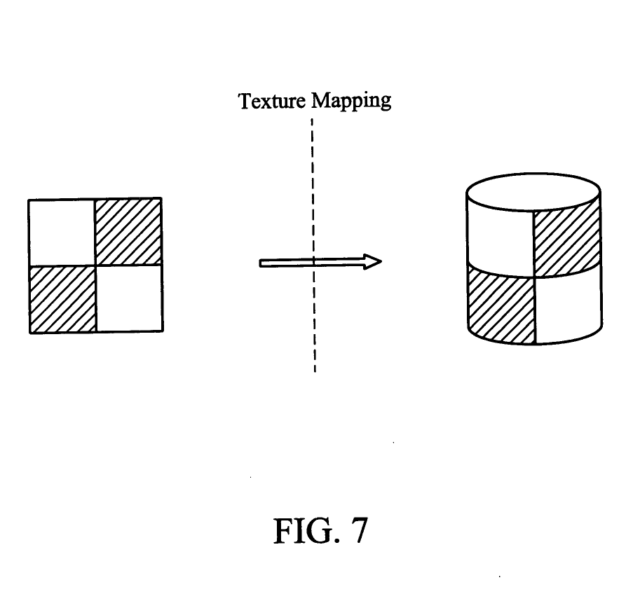

The rotation module 302 then rotates the variation object as a rotation object according to a rotation requirement, and the texture mapping module 303 rotates a 2D texture as a 3D texture according to the rotation requirement and texture maps the 3D texture on the rotation object. It should be noted that an example of texture mapping is shown in FIG. 7.

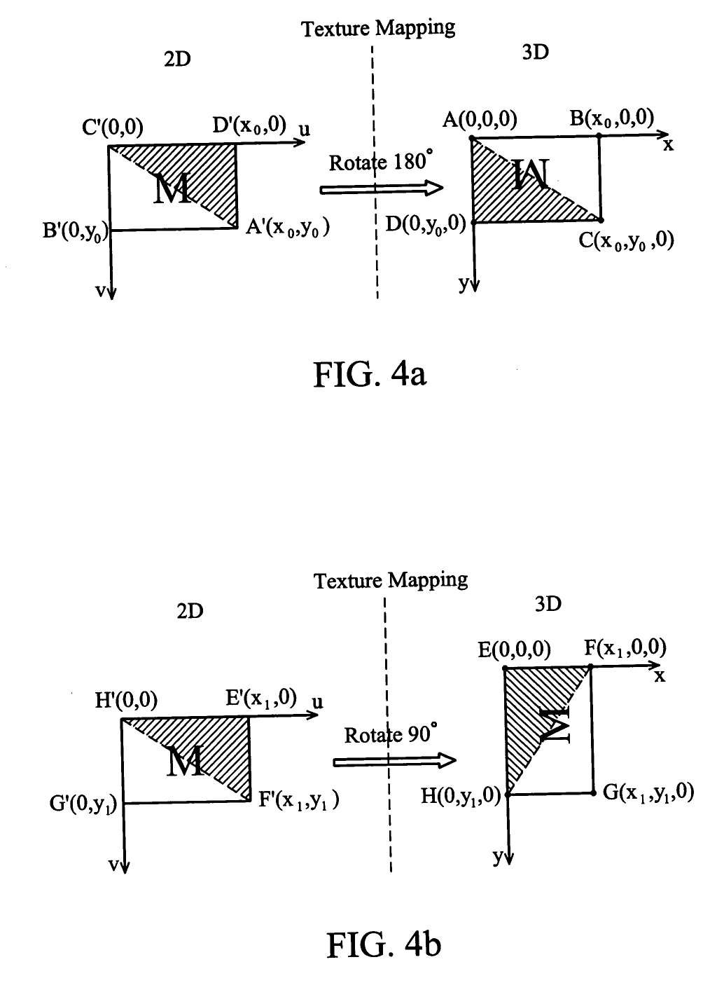

FIG. 4a illustrates a 2D texture by 180° rotated into 3D texture. The original image of the triangle is filled with oblique lines. The texture mapping module 303 combines two triangles (triangle A′B′C′ and A′C′D′) to form a rectangle and thereby achieve the object of rotating the triangle. For each vertex, the relation between 2D and 3D texture mapping is: the coordinates of the vertex A′ are transformed from (x₀,y₀) into (0,0,0); the coordinates of the vertex B′ are transformed from (0,y₀) into (x₀,0,0); the coordinates of the vertex C′ are transformed from (0,0) into (x₀,y₀0); and the coordinates of the vertex D′ are transformed from (x₀,0) into (0,y₀,0).

FIG. 4b illustrates a 2D texture with 90° rotated into 3D texture. The original image of the triangle is filled with oblique lines. The texture mapping module 303 combines two triangles (triangle E′F′H′ and F′G′H′) to form a rectangle and thereby achieve the object of rotating the triangle. For each vertex, the relation between 2D and 3D texture mapping is: the coordinates of the vertex E′ are transformed from (x₁,0) into (0,0,0); the coordinates of the vertex F′ are transformed from (x₁,y₁) into (x₁,0,0); the coordinates of the vertex G′ are transformed from (0, y₁) into (x₁,y₁,0); the coordinates of the vertex H′ are transformed from (0,0) into (0,y₁,0).

The operation applied in the 3D engine is described as follows. The rotation object determination module 304 detects the shape, position, and rotation angle of the variation object in the image. The rotation module 302 rotates vertices of the triangles of the variation object. For example, in FIG. 4a, two triangles (triangle A′B‘C’ and A′C′D′) are rotated. The coordinates of the vertex A′ are transformed from 2D coordinates (x₀,y₀) into 3D coordinates (0,0,0); the coordinates of the vertex B′ are transformed from 2D coordinates (0,y₀) into 3D coordinates (x₀,0,0); the coordinates of the vertex C′ are transformed from 2D coordinates (0,0) into 3D coordinates (x₀,y₀,0); and the coordinates of the vertex D′ are transformed from 2D coordinates (x₀,0) into 3D coordinates (0,y₀,0). Finally, the texture mapping module 303 rotates and texture maps the texture on the original triangle to the rotated triangle.

After texture mapping, the 3D engine 300 replaces a partial image of the image in the second memory block 312 corresponding to the position of the variation object in the image rendered by the rendering module 301. Afterward, the display device 320 can refresh and display the updated image in the second memory block 312. It should be noted that the rotation requirement can be preset by system or users.

In the second embodiment, the rendering module 301, the rotation module 302, the texture mapping module 303, and the rotation object determination module 304 are components of the 3D engine 300, that is, they are implemented by hardware (hardware rendering) and performed by the graphics device, such as a graphics accelerator.

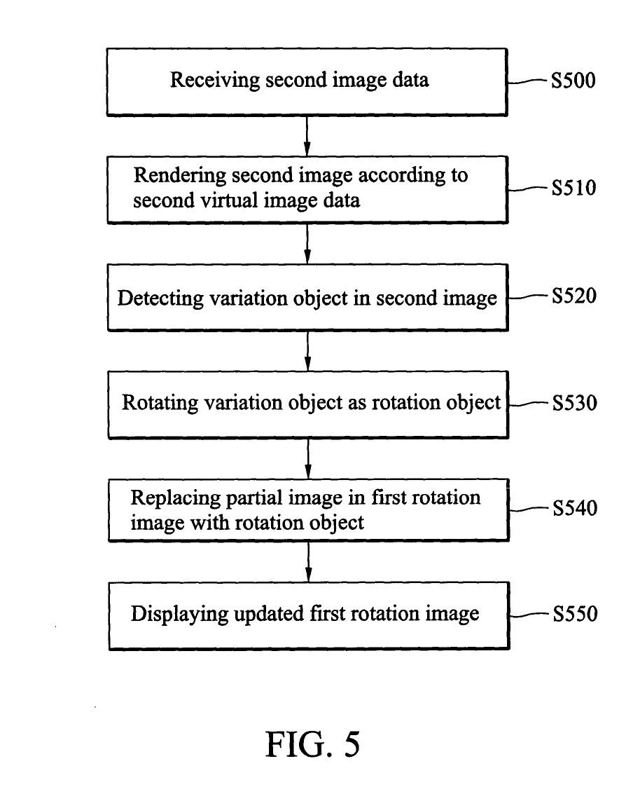

FIG. 5 illustrates the operation of the method for image rotation according to the embodiment of the present invention. Note that, the image data and prior image data received by the rendering module is referred to as the second image data and first image data, and the corresponding rotated image is referred to as the second rotation image and first rotation image, respectively.

First, in step S500, second image data is received, and in step S510, a second image is rendered according to the second image data, and stored.

Then, in step S520, a variation object in the second image is detected according to a first image and the second image. Thereafter, in step S530, the variation object is rotated as a rotation object according to the rotation requirement. Similarly, the rotation requirement can be preset by system or users.

Thereafter, in step S540, a partial image of the first rotation image corresponding to the first image corresponding to the position of the variation object in the second image is replaced with the rotation object. Finally, in step S550, the updated first rotation image is refreshed and displayed.

It should be noted that if the image is rendered by the 3D engine, a texture is rotated according to a rotation requirement, and the rotated texture is texture mapped to the rotation object before the partial image is replaced with the rotation object. Further, if the display device is rotated at an angle, the variation object can be rotated according to the angle as the rotation object.

Similarly, the rendering process and rotation process can be implemented by software or hardware, and performed by the CPU or graphics accelerator, respectively.

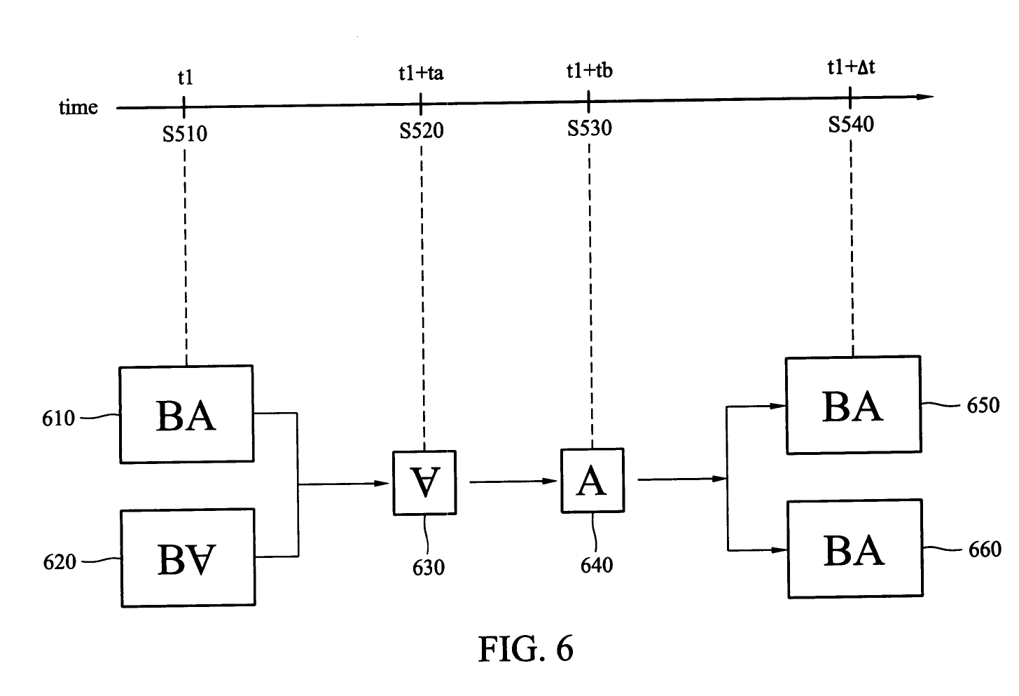

FIG. 6 illustrates an example of image rotation with time progress. At time t1, the system stores a first image 610, and a second image 620 to show next. The first image 610 and the second image 620 are stored in the rendering module 220 and the first memory 200, respectively.

At time t1+ta, the rotation object determination module 224 detects a variation object 630 between the first image 610 and the second image 620. At time t1+tb, the rotation module 220 rotates the variation object 630 by 180° to generate a rotation object 640. At time t1+Δt, the partial image in the first image 610 is replaced with the rotation object 640, thereby generating the updated first image 650, and the updated first image 650 can then be rotated and displayed.

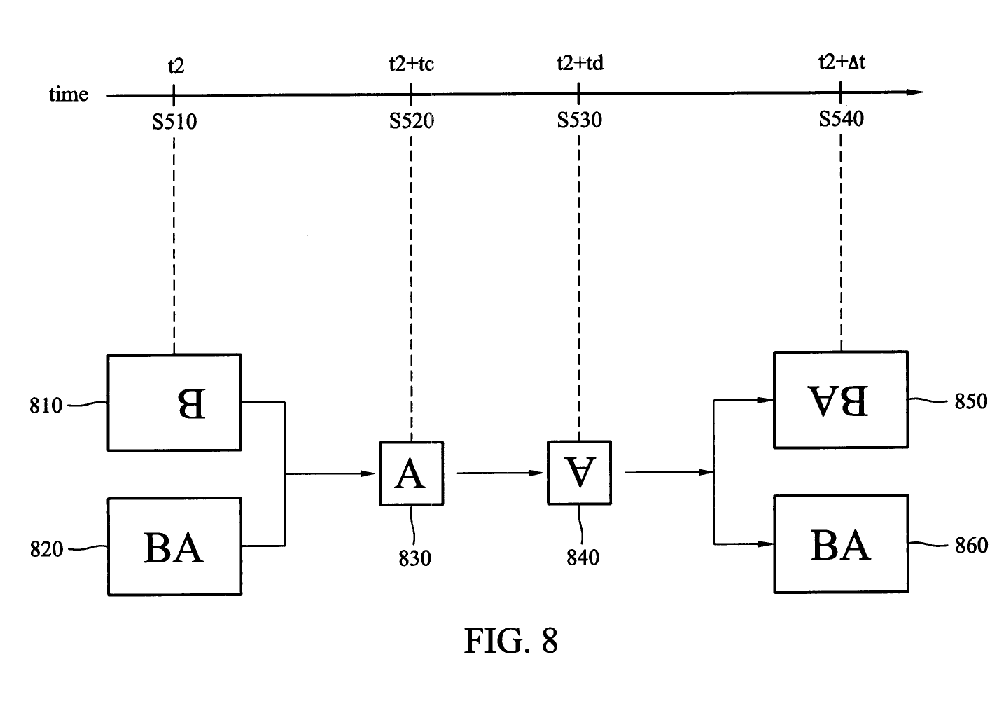

FIG. 8 illustrates another example of image rotation with time progress. In this example, the image without rotation is displayed when the display device is rotated by 180°.

At time t2, the system stores a first image 810, and a second image 820 to show when the display device rotated by 180° next.

At time t2+tc, the rotation object determination module 224 detects a variation object 830 between the first image 810 and the second image 820. At time t1+td, the rotation module 220 rotates the variation object 830 by 180° to generate a rotation object 840. At time t2+Δt, the partial image in the first image 810 is replaced with the rotation object 840, thereby generating the updated first image 850, and the updated first image 850 can then be rotated and displayed.

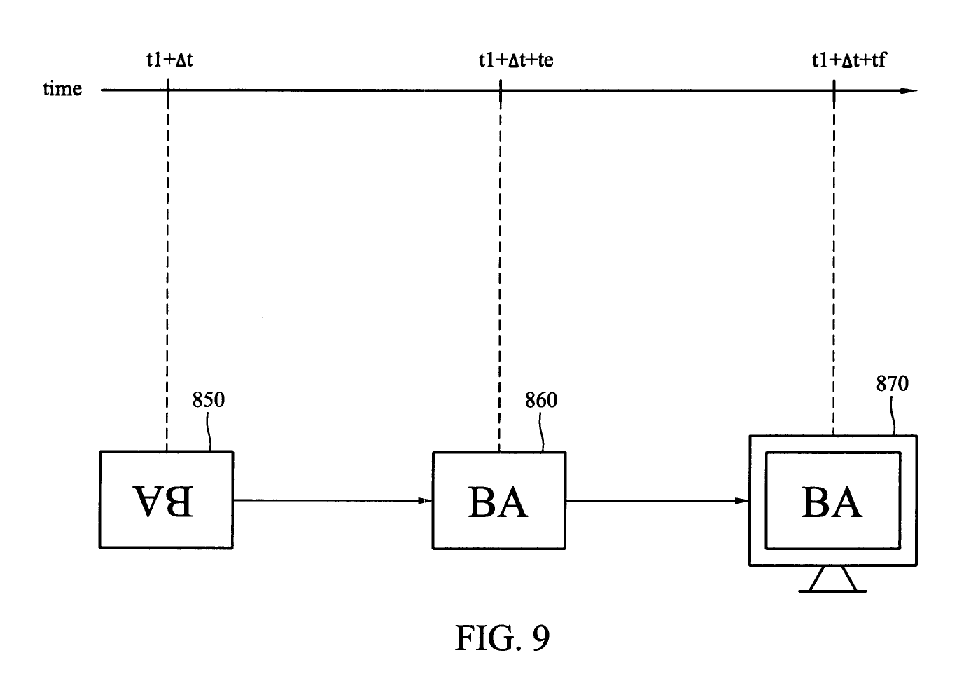

FIG. 9 illustrates the process of image rotation and image refreshing. First, the first image 850 is rotated as the first rotation image 860, and the first rotation image 860 is refreshed by the display device.

As a result, the apparatus and method for image rotation according to the present invention can rotate only the changed elements in the image without rendering the entire image, thereby improving system performance and reduce system resources used by the rendering process. Further, since the present invention can be implemented by hardware, such as graphics accelerators, the response time when refreshing the image in the frame buffer is reduced.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. An apparatus for image rotation, comprising:
a first memory;
a frame buffer to store a first rotation image corresponding to a first image;
a rendering module to receive second image data, render a second image according to the second image data, and store the second image in the first memory;
a rotation object determination module to detect a variation object changed between the first image and the second image according to the first image and the second image; and
a rotation module to rotate the variation object as a rotation object, and replace a partial image of the first rotation image located at a position corresponding to that of the variation object in the second image with the rotation object.

2. The apparatus as claimed in claim 1, further comprising a display device to refresh and display the first rotation image in the frame buffer.

3. The apparatus as claimed in claim 1 wherein the first memory is the system memory of a computer system.

4. The apparatus as claimed in claim 3 wherein the rendering module and the rotation module are implemented by software, and performed by the CPU of the computer system.

5. The apparatus as claimed in claim 1 wherein the first memory is located in the frame buffer.

6. The apparatus as claimed in claim 5 wherein the rendering module and the rotation module are implemented by hardware, and performed by a graphics accelerator.

7. A method for image rotation, comprising the steps of:
providing a first rotation image corresponding to a first image receiving second image data;
rendering a second image according to the second image data;
detecting a variation object changed between the first image and the second image according to the first image and the second image;
rotating the variation object as a rotation object; and
replacing a partial image of the first rotation image located at a position corresponding to that of the variation object in the second image with the rotation object.

8. The method as claimed in claim 7 further comprising storing the first rotation image in a frame buffer.

9. The method as claimed in claim 8 further comprising displaying the first rotation image in the frame buffer.

10. The method as claimed in claim 7 further comprising storing the second image in the system memory of a computer system.

11. The method as claimed in claim 7 further comprising rotating a texture according to a rotation requirement, and texture mapping the rotated texture on the rotation object.

12. The method as claimed in claim 10 wherein the rendering process and rotation process are performed by the CPU of the computer system.

13. The method as claimed in claim 8 further comprising storing the second image in the frame buffer.

14. The method as claimed in claim 13 wherein the rendering process and rotation process are performed by a graphics accelerator.

15. The method as claimed in claim 7 wherein the variation object is rotated as the rotation object according to a display device with an angle rotated.

16. An apparatus for image rotation, comprising:
a frame buffer including a first memory block and a second memory block to store a first rotation image corresponding to a first image;
a 3D engine, including:
a rendering module to receive second image data, render a second image according to the second image data, and store the second image in the first memory block;
a rotation object determination module to detect a variation object changed between the first image and the second image according to the first image and the second image;
a rotation module to rotate the variation object as a rotation object according to a rotation requirement; and
a texture mapping module to rotate a texture according to the rotation requirement, and texture map the rotated texture on the rotation object;
wherein the 3D engine replaces a partial image of the first rotation image located at a position corresponding to that of the variation object in the second image with the rotation object after the rotation object is texture mapped.

17. The apparatus as claimed in claim 16 further comprising a display device to refresh and display the first rotation image in the second memory block.
